(19) United States
(12) Patent Application Publication
(10) Pub. No.: US 2004/0133861 A1
(43) Pub. Date: Jul. 8, 2004

(54) Method for generating electronic circuits

(76) Inventors: Gianmario Bollano, Torino (IT); Maura Turolla, Torino (IT); Marcello Valentini, Torino (IT); Stefano Vercelli, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/483,450

(22) PCT Filed: Jul. 9, 2002
(86) PCT No.: PCT/IT02/00449

(30) Foreign Application Priority Data
Jul. 10, 2001 (IT) TOO1AOOO667

(51) Int. Cl. G06F 17/50

(52) U.S. Cl. 716/4

(57) ABSTRACT

The present invention relates to a method for obtaining electronic circuits wherein the design steps (100) constituted by a first development and testing cycle (200), of the functional type, and a second development and testing cycle (300), of the architectural type, are managed using, as inputs, for both cycles (200 and 300) the same configuration files (140) and stimuli (150) and generating, at the output, results having equivalent (230, 330) and comparable (333) formats. Thanks to these characteristics, it is possible to conduct in integrated fashion functional tests (220) and architectural tests (320) on corresponding functional and architectural models of electronic circuits and verify the perfect correspondence between the different types of models as the configurations files (140) and stimuli (150) vary.

### TECHNICAL FIELD

The present invention relates to a method for generating both models of electronic circuits and corresponding circuits starting from description languages at different abstraction levels.

In particular, the present invention relates to the method for designing and synthesising decoding circuits within the telecommunications field, such as Reed Solomon circuits.

### BACKGROUND ART

In the prior art the use is known of programming language to design models of electronic circuits and corresponding circuits.

For instance, in accordance with the prior art, the design of a complex integrated circuit or SOC (System On Chip) and of the elementary circuits that compose it requires a first development and testing cycle, aimed at conducting a functional analysis of the SOC and of the circuit models that compose it, and a second development and testing cycle, aimed at an architectural verification of the elementary circuits that compose the complex integrated circuit, in view of the realisation, for instance by synthesis, of the actual circuits, of the SOC or of an equivalent complex electronic circuit.

In the first development and testing cycle, a language at high level of abstraction is used, for instance C++, and the models of the elementary circuits that constitute the SOC are generated (functional models).

In this way, in accordance with the prior art it is possible to verify the functionality both of the SOC and of the circuits that constitute the SOC without specialising the circuits themselves.

The first development and testing cycle, for instance, comprises, in regard to the functional test of a specific type of circuit, the steps of:

1a)—describing a functional model of the circuit in the high level language,

1b)—compiling the generated model,

1c)—functionally simulating the circuit model according to predefined specifications or to a reference standard

1d)—repeating in sequence the steps 1a), 1b), 1c) until obtaining a determined model of the circuit deemed to comply with the predefined specifications or to the reference standard (specifications).

After completing the first high level development and testing cycle, the second development and testing cycle is activated, which, for instance, comprises the steps of:

2a)—describing an architectural model of the circuit (a circuit) with a second programming language, for instance the VHDL (Very high speed integrated circuit Hardware Description Language) programming language, having, as is well known, a lower level of abstraction and in general such as to allow to obtain the circuit by synthesis;

2b)—compiling the architectural model;

2c)—simulating the architecture of the circuit taking into account parameters that are generally different from those used in the first development and testing cycle, for instance signal exchange timing, precision of the data, precision of the operations.

In accordance with the prior art, if inconsistencies are noted and the architectural simulation yields incongruous results, the first and/or the second cycle are repeated until obtaining a determined circuit having both functional and architectural characteristics that meet specifications.

A first technical problem of the prior art is that the execution and the completion of said two cycles is extremely uncertain, since the first description, compilation and simulation cycle is completely distinct and separate from the second one and, therefore, only the expertise of an expert designer can assure the consistency of the results obtained during the first cycle with those obtained during the second one.

In other words, the prior art does not assure that the electronic circuit obtained corresponds to the initial functional specifications.

A second technical problem of the prior art is that the execution times of the first and of the second cycle are extremely high because any modification, both functional and architectural of the complex electronic circuit and/or of the circuits that compose it entails additional descriptions, compilations and simulations.

Naturally, such problems are very acutely felt in the case of circuits with high functional and architectural variability.

Take, for instance, the generation of complex electronic circuits that comprise Reed Solomon decoding circuits.

It is well known that the Reed Solomon (RS code) encoding and corresponding decoding is characterised by some parameters that in fact determine, once they are specialised, both the functional characteristics and the architectural characteristics of the RS decoding circuit.

Such parameters are:

N=number of symbols included in each elementary information block (word) transmitted, the word comprises both useful information and encoding information or code;

M=number of bits per symbol;

K=number of symbols that contain the useful information in which K has as a constraint K≦N-2, and N-K represents the number of symbols added by the encoder;

T=(N-K)/2 maximum number of erroneous symbols that a decoding circuit RS can identify and correct;

It is also known that time domain decoding of the RS type and the corresponding RS decoding circuit model (RS circuit model) 10 (FIG. 1) comprise the following function blocks: a block for assessing the so-called syndrome polynomial (syndrome block) 11, a block for computing the so-called error localisation polynomial and the so-called error amplitude polynomial (error block) 12, a block for generating the correction symbols (correction block) 14, a delay block or line 15 of the incoming symbols and a symbol sum block (sum block) 18.

The syndrome block 11 is able, as is well known, to receive the incoming symbols (I) and to transfer them in cascade arrangement, after processing, to the error block 12, to the corrections block 14 and to the sum block 18, respectively. The sum block 18 is able, as is well known, to sum the delayed symbols from the delay line 15 to the correction symbols coming from the corrections block 14 in such a way as to generate correct output symbols (O).

A first problem, typical in the design of SOC or of electronic circuits that comprise RS circuits, resides in the difficulty of determining a priori, based only on the functional information of the SOC, the characteristics of the RS circuit to be obtained, so that the two development and testing cycles must be repeated several times for the sole purpose of determining the parameters of the RS circuit.

A second problem, typical of designs that include RS circuits, resides in the fact that, once the parameters of the RS circuits are determined, it is necessary to repeat the two SOC development and testing cycles, described above, in order optimally to configure the RS circuit and the SOC in the determined context of the design to be achieved.

During the repetition of the first cycle, as an additional problem of the prior art for this type of design, it can for instance happen that at the functional level the model of the SOC does not meet the specifications because, due to the determined design context, the RS circuit model 10 is not able to correct error in a manner that is adequate to the needs.

In such a case, it becomes necessary either further to develop and test the modules of the SOC model so that functionally the entire SOC meets design specifications or to redefine the parameters of the RS circuit model 10.

During the repetition of the second cycle, due to the different development environment and of the poor integration between the first and the second cycle, it may occur that the simulation of the RS circuit yields unsatisfactory results. In particular, it may occur that the signal exchange timing and/or the precision of data and operations entail, during the simulation, unacceptable results in view of obtaining a determined circuit in relation to said second cycle. Because of this additional problem, it may therefore become necessary either to repeat the second cycle only, waiving functional and architectural design consistency, or to repeat the first and the second cycle again.

In essence, the prior art does not teach a simple and effective method for avoiding to repeat the first and the second development and testing cycle several times and, therefore, it does not allow to solve both the general and specific design problems described above.

### DISCLOSURE OF THE INVENTION

The aim of the present invention is to describe a method that solves the problems of the prior art.

In particular, the aim of the present invention is to describe a method wherein the first development and testing cycle is integrated with the second cycle in order to allow, in the various design situations, certain consistency between the functional tests and the architectural tests.

The aim is achieved by the method for generating electronic circuits as described in the claims.

In particular, the aim is achieved by the method for generating electronic circuits, according to the invention, wherein an appropriate interface module allows to use the same configuration information and stimuli to conduct both the first and the second development and testing cycle.

Moreover, according to an additional characteristic of the present invention, the aim is achieved by the method for generating electronic circuits wherein the description of the functional models of the circuit to be realised is equivalent to that of the respective architectural models.

Lastly, according another characteristic of the present invention, the aim is achieved by the method for generating electronic circuits wherein the variation of the configuration information does not require, in view of the functional analysis and of the architectural analysis, either an update of the description of the functional models or an update of the description of the architectural models of the circuits to be obtained.

### BRIEF DESCRIPTION OF DRAWINGS

This and other characteristics of the present invention shall become readily apparent from the description that follows of a preferred embodiment, provided by way of non limiting example with the aid of the accompanying drawings, in which:

FIG. 1 shows a general block diagram of a model of Reed Solomon decoding circuit; and

FIG. 2 shows a flowchart of the method according to the invention.

### BEST MODE FOR CARRYING OUT THE INVENTION

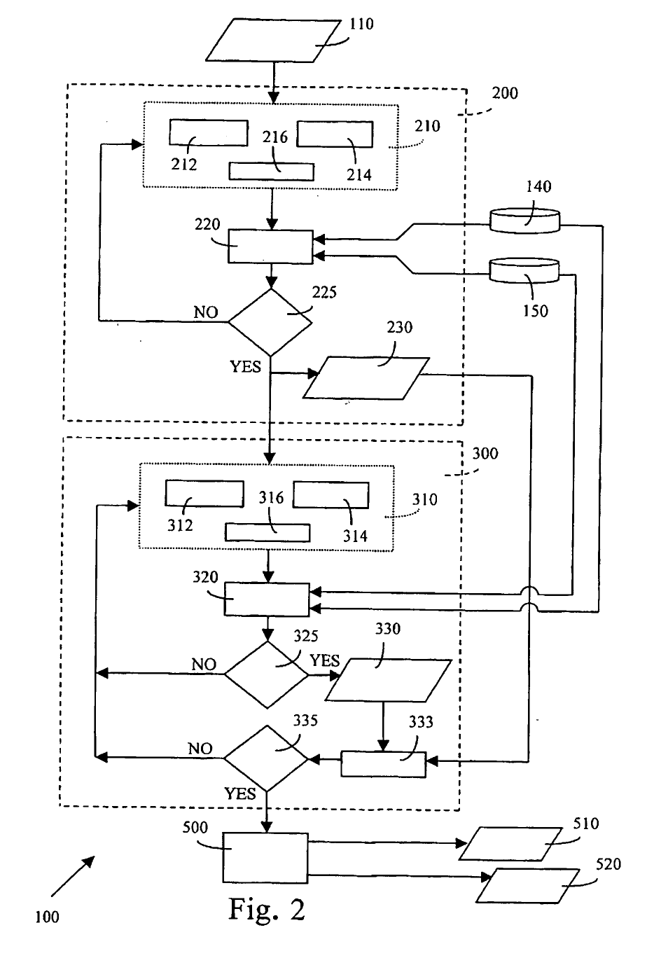

With reference to FIG. 2, the method for making electronic circuits, according to the invention, is represented by the flowchart 100 in which a set of steps allow to obtain both elementary circuits belonging to the SOC and the SOC itself.

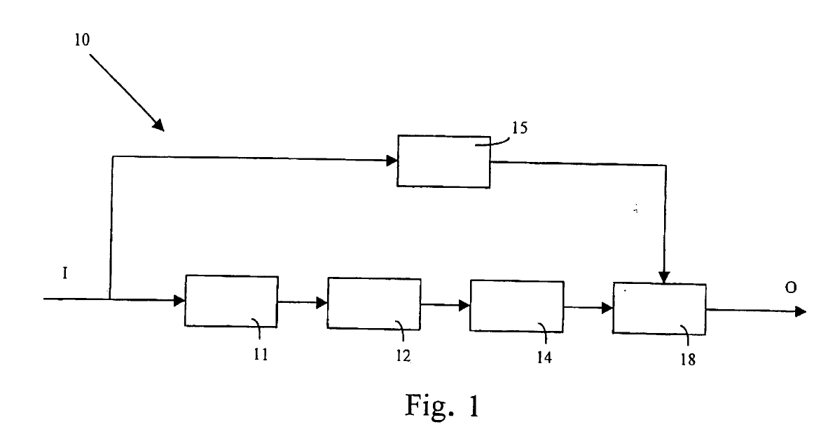

The method is described herein taking as reference the model of RS circuit 10 (FIG. 1, FIG. 2) but, as shall be readily apparent to a person versed in the art, such characteristics can easily be extended to electronic circuits of different types and, hence, are not limited to the type of circuit taken as an example.

The flowchart 100 comprises a block 200 representative of a first development and testing cycle at the functional level, and a second block 300 representative of a second development and testing cycle at the architectural level.

In the block 200, a first step 210 is representative of the phases of describing, for instance in C++ language, both models of circuits to be realised 212 and blocks of software code 214 and 216, as shall be described in detail hereafter, and in block 300, a first step 310 is representative of the phases of describing, for instance in VHDL language, both corresponding circuits to be realised 312 and hardware code blocks 314 and 316, corresponding to the blocks 214 and 216, as will be described hereafter.

In accordance with the present embodiment, the description of the models (functional description or software) 212, given determined general operating specifications 110, is aimed at generating the functional description, for instance, of the model of RS circuit 10. The corresponding description of the circuit (architectural or hardware description) 312 is aimed at generating the description of the circuit, for instance the circuit RS, to be realised.

The functional description 212, in accordance with a first description criterion characteristic of the present invention, must be performed in such a way that each function block (11, 12, 14, 15, 16) can be replaced by corresponding and equivalent circuit blocks during the corresponding architectural description step 312.

By way of example, a form of implementation of said first criterion is shown below, relative to the functional description in C++ language of the syndrome block 11 and to the corresponding architectural description in VHDL language of the same block.

Taking as a reference the decoding algorithm for RS codes, the evaluation of the syndromes is defined, as is well known, by means of the following relationships (1) and (2):

$$\begin{matrix}S ( x ) = {\sum }_{i = 0}^{2 T - 1} {S}_{i} \cdot {x}^{i} & ( 1 ) \\ {S}_{i} = {\sum }_{μ = 0}^{N - 1} {c}_{μ} \cdot {α}^{μ \cdot ( i + H )} & ( 2 )\end{matrix}$$

in which

μ: corresponds to the index relating to the number of symbols that form the word;

c_{μ}: represents the symbols that form a code block, comprising both the information symbols (the first K symbols) and the redundancy symbols added by the encoder (the last N-K);

α: represents a primitive of the so-called Galois field whereon, as is well known, the RS code is defined;

H represents, as is well known, the power of the primitive α that constitutes the first 0 of the polynomial generator of the RS code.

The direct implementation of the formulas (1) and (2) in C++ language would be a source of considerable difficulties for an equivalent implementation in VHDL language and, therefore, in accordance with the present embodiment, the formula (2) is preferably re-written with the co-called Horner's rule, known in itself, and the following is obtained:

$$\begin{matrix}{S}_{i} = {c}_{0} + {c}_{1} \cdot {α}^{( i + H )} + {c}_{2} \cdot {α}^{2 \cdot ( i + H )} + … + {c}_{N - 1} \cdot {α}^{( N - 1 ) \cdot ( i + H )} = \\ = {c}_{0} + {α}^{( i + H )} \cdot [ {c}_{1} + {α}^{( i + H )} \cdot [ {c}_{2} + {α}^{( i + H )} \cdot [ … ] ] ]\end{matrix} \qquad ( 3 )$$

This formula (3), constituted by the repetition of a product and a sum, can, as will be readily apparent to person versed in the art, be easily implemented both in C++ language (software) and in VHDL language (hardware).

In C++ language the formula (3) can be implemented by means of the code strings that follow (Tab.1) in which are inserted, for the sake of additional clarity, explanatory comments according to the conventions of the C++ language:

TABLE 1
SYNDROME EVALUATION CODE IN C++ LANGUAGE

```
// External cycle to consider all symbols of the code block
for (int u = 0; u < n; u++) {
  // Internal cycle to compute the N−K partial syndromes ...
  for (int i = n−k−1; i >= 0; i−−) {
  // Applying Horner's theory to compute each term enclosed in square
  // brackets in the formula (3)
  synd_pol[i] = sym_in[u] \hat{ } (mult.evaluate(synd_pol[i],
  alpha_pows[(i+h) % n]));
  }
}
```

In which the division into a double iterative cycle allows to separate, in computing the syndromes, the data succession information in time (external cycle) from the actual operations carried out on the symbols (internal cycle).

Note, additionally, that the internal cycle is expressed with an iterative expression to allow its effective and equivalent hardware implementation, in accordance with what is indicated as the first description criteria.

The corresponding hardware description of the syndrome evaluation block, in accordance with the present embodiment, makes use of a sub-module (Tab. 2) that obtains the product and the sum accumulating the result, i.e. computes partial syndromes.

The internal cycle of the previous description in C++ code is thereby translated into VHDL language in a form that can be realised in simple fashion with hardware logic functions. The sub-module in VHDL language (Tab. 2) is instanced N-K times to compute the N-K coefficients of the syndromes polynomial exploiting a parallel architecture. This mechanism, already present in the form of iterative cycle in the software description (Tab.1), allows to describe at the hardware level (Tab.2) a configurable (scaleable) circuit block, as the code parameters vary (N, K, H), and assures the equivalence between software model and hardware model.

TABLE 2
SYNDROME EVALUATION CODE IN VHDL LANGUAGE

```
G_SYNDPOL_PEs: for I in N−K−1 downto 0 generate
  I_SYNDEVAL_STAGE: RS_SYNDEVAL_STAGE
    generic map (
    M => M,
    DELAY => 1,
    GENPOL => GENPOL)
    port map (
    N_RST => N_RST,
    CLK => CLK,
    EN_I => DVAL_I,
    SYMB_I => DATA_I,
    APOW_I => ALPHA_POWS((I+H) mod N),
    START_I => START_I,
    DATA_O => SYNDPOL_INP((I+1)*M−1 downto I*M));
end generate G_SYNDPOL_PEs;
```

Note that the external cycle of the C++ code (Tab.1) identifies the succession of the symbols in the time base, therefore it is intrinsically realised by the simulation of the VHDL code (Tab.2) as is readily apparent to a person versed in the art.

In detail, in the hardware description of the RS circuit is also provided a more external module to the syndrome evaluation block, not shown herein, which passes to the syndrome sub-module the N symbols of the code block at the decoder input, thereby serving the same function as the C++ code (Tab.1) but adding, as is obvious, the synchronisation information that is typical of hardware descriptions.

Applying the first description criterion to all the function blocks (11, 12, 14, 15,18) of the RS circuit model 10, it is thus possible to obtain a set of functional description that can be easily replaced by corresponding architectural descriptions.

The functional description 212 of the RS circuit model 10 and the corresponding architectural description, in accordance with a second description criterion, characteristic of the present invention, must be parametric in order to be specialised, as parameters vary, with no need to compile the various functional or architectural blocks. In accordance with said second characteristic criterion of the present invention, in the software and hardware description provided below in Tab.3 and Tab.4, respectively, the parameters N, K and H of the RS code are in the form of variables, as in expressions (1),(2), (3).

This is necessary to obtain a universal description of the RS module, i.e. one that is independent from a specific application or a predefined standard.

The C++ code (Tab.3) and the corresponding VHDL (Tab.4) thus written is therefore found suitable to realise a multiplicity of Reed Solomon circuits without requiring further modifications to the C++ or VHDL descriptions as parameters vary.

A form of implementation of said second description criterion is provided below in Tab. 3 and Tab.4

In detail, the fact that the software description 212 is parametric is visible through the use in Tab.3 of the parameters n_val, k_val, m_val and h_val passed to the syndrome calculation function (RS_SyndromeEval):

TABLE 3
RS_SyndromeEval SOFTWARE MODEL

```
RS_SyndromeEval::RS_SyndromeEval(int n_val, int k_val, int m_val,
BitVector poly,
int h_val)
  : mult(poly)
{
  n = n_val;
  k = k_val;
  h = h_val;
  synd_pol = new BitVector[n−k];
  for (int i = 0; i < n−k; i++) synd_pol[i].init(m_val);
}
```

In the case of the hardware description 312, for instance in VHDL language, the same parameters are obtained as generic declarations of N, K, M and H, as is readily apparent from the example of VHDL code of the component RS_SYNDEVAL (Tab.4):

TABLE 4
RS_SYNDEVAL HARDWARE MODEL

```
  generic (
  N : integer := 255;
  K : integer := 239;
  M : integer := 8;
  H : integer := 0;
  GENPOL : integer := 285;
  ARCH_TYPE : integer := 0);
  port (
  N_RST : in std_ulogic;
  CLK : in std_ulogic;
  DATA_I : in std_ulogic_vector (M−1 downto 0);
  DVAL_I : in std_ulogic;
  START_I : in std_ulogic;
  SYNDPOL_O : out std_ulogic_vector ((N−K)*M−1 downto 0);
  DVAL_O : out std_ulogic);
end component;
```

Applying the second description criterion to all the function blocks (11, 12, 14, 15,18) of the RS circuit model 10 it is thus possible to obtain a set of functional descriptions (software) and corresponding architectural descriptions (hardware) that are parametric and, hence, easily adaptable as specific applications or predefined standards of the electronic circuits to be realised vary.

The software description 212 of the RS model 10, in accordance with a third description criterion, characteristic of the present invention, shall use precision data that are equivalent to those of the hardware description 312, once the description of the individual function blocks is complete.

In accordance with the present embodiment, therefore, the equivalence between software model (C++) and hardware model (VHDL) is obtained not only by assuring the scalability of the sub-modules (first description criterion) and using the same parameters (second description criterion), but also using, for the function models, types of data that allow a strict control over precision (third description criterion).

As is well known, hardware description languages accurately define the precision of the data and of the operations, but this control is normally absent in software description languages, for instance the C++ language.

In accordance with the present embodiment and according to the aims of the invention, said deficiency is solved by defining a specific “BitVector” type of data or class and the operations applicable thereto.

The “BitVector” class and its operators, as is readily apparent to a person versed in the art, allow in C++ language to control precision down to the bit, as is the case for hardware description languages, for instance with the “logic” and “logic_vector” types of the VHDL language.

By way of example, the following Tab.5 provides the code in C++ language, accompanying by appropriate comments, that corresponds to the definition of the “BitVector” class:

TABLE 5
PRECISION 0F DATA AND OPERATIONS

```
// Definition of the BitVector class
class BitVector{
  bool *vector;
  int marg1;
  int marg2;
  bool destructor_flag;
public:
  // Constructor of the BitVector class
  BitVector( ) { vector = NULL; }
  BitVector(const int dim);
  BitVector(const int margin1, const int margin2);
  BitVector(const char* s);
  BitVector(const BitVector&);
  // Destructor of the BitVector class
  ˜BitVector( ) { if(vector != NULL && destructor_{—}
  flag == 1) delete [] vector;}
  // List of operators defined for the BitVector for different types of
  operandi
  friend ostream& operator<<(ostream& stream, BitVector v);
  BitVector operator=(char*);
  BitVector operator=(BitVector);
  BitVector operator=(char);
  BitVector operator=(bool);
  BitVector operator( ) (int index);
  BitVector operator( ) (int margin1, int margin2);
  BitVector operator, (BitVector);
  BitVector operator<<(int);
  BitVector operator>>(int pos);
  BitVector operator&(BitVector);
  BitVector operator|(BitVector);
  BitVector operator\hat{ }(BitVector);
  BitVector operator˜( );
  BitVector operator!( );
  BitVector operator+(BitVector);
  BitVector operator−(BitVector);
    bool operator==(BitVector);
    bool operator>(BitVector);
    bool operator<(BitVector);
    bool operator>=(BitVector);
    bool operator<=(BitVector);
      operator bool ( ) {return vector[0];}
// Utility functions
void init(int dim);
  int size( ) { return ( abs( (marg1-marg2) ) + 1); }
  BitVector reverse( );
  BitVector extend(int add_pos);
  friend bool ReduceXor(BitVector);
  void reset( );
  // Functions for conversion from/to BitVector
  friend BitVector ToBitVector(long val, int size);
  friend BitVector ToBitVector(bool* b, int size);
  friend BitVector ToBitVector(bool* b, int margin1, int margin2);
  friend unsigned long ToUnsigned(BitVector);
  friend long ToSigned(BitVector);
  friend char* ToCharPointer(BitVector);
  friend bool* ToBoolPointer(BitVector);
};
```

Applying the third description criterion to the RS circuit model 10 it is thus possible to obtain a functional or software model having equivalent characteristics, in terms of data and operations precision, equivalent to those of the corresponding hardware model, not shown herein as it is typical of said description type.

The steps 212 and 312 therefore allow, by means of the use of the indicated criteria, to obtain software and hardware descriptions that are substantially equivalent of models of electronic circuits and of corresponding circuits.

The steps 214 and 216 pertain to the generation of blocks of software code, for instance in C++ language, whereof the first block is aimed at interfacing the circuit model to appropriate external files (140, 150) (description of interface blocks) 214 and the second block is aimed at conditioning, with the information contained in said files (140, 150), the circuit model (description of application blocks) 216.

The corresponding steps 314 and 316 pertain to the generation of blocks of hardware codes, for instance in VHDL language, whereof the first block is aimed at interfacing the circuit to the external files (140, 150) themselves (description of interface blocks) 314, in accordance with one of the main characteristics of the present invention, and the second block is aimed at conditioning, with the information contained in said files (140, 150), the circuit (description of application blocks) 316.

The distinction between description of interface blocks, 214 and 314, description of application blocks, 216 and 316, is purely logical and used for the sole purpose of making the invention clearer; in fact, at the practical level, the description of the interface and application blocks, 214 and 216 or, respectively, 314 and 316, in the corresponding languages and levels of abstraction, are generally contained in appropriate modules, respectively called software test bench module and hardware test bench module.

Also for the description of the software test bench (steps 214 and 216) and the corresponding hardware description (steps 314 and 316), the realisation of a model and corresponding RS circuit is taken as a reference, but it is clear that the method and the realisation criteria suggested herein are not limited to the described embodiment, but are to be considered extensible to the generality of cases.

The description of the software test bench module (214, 216) and of the corresponding hardware module (314, 316) must, in accordance with the present embodiment and with one of the main characteristics of the present invention, allow to use the same external data, for instance constituted, respectively, by a configuration file 140 and by a stimuli file 150.

The software and hardware test bench modules, therefore, must be generated in such a way as to be able to read a single configuration file 140, containing, for instance, the configuration parameters of the Reed Solomon decoder (i.e. the value of N, K, M, etc.) and a single stimuli file 150, containing, for instance, the stimuli to pass as inputs to the decoder RS to verify its functionality.

For instance, in the case of the RS circuit model 10 and of the RS circuit, the configuration file 140, to meet the indicated characteristics, has a shape of the type set out in the Tab.6 that follows:

TABLE 6
RS CONFIGURATION FILE

| | |
|---|---|
| 255 | N |
| 239 | K |
| 8 | M |
| 0 | H |
| 285 | POLGEN |
| 8 | FWSIZE |
| 55 | MEM_CONF |

The table shows the value of the parameters of the RS code, identified by the comment on the same line; note that, in addition to the parameters N, K, M, H, described previously, and a GENPOL parameter, which identifies the polynomial that generates the Galois field whereto the primitive a in the previously described relationships (2) and (3) belongs, in the configuration file 140 values are also assigned to two other parameters, indicated as FWSIZE and MEM_CONF and representative of configuration parameters of a memory external to the Reed Solomon circuit, as shall be described in detail hereafter.

These two parameters are, as is obvious, of the architectural type and, therefore, they have no influence on the functional description of the RS circuit model.

The parameters FWSIZE and MEM_CONF are therefore inserted in the configuration file 140 to be ignored by the (functional) software test bench module and to be used exclusively by the (architectural) hardware test bench.

The software test bench, relative to the interface block part, in accordance with the present embodiment, is able to read from the configuration file 140 its own configuration (coinciding with the parameters N, K, M, H, GENPOL), applying it to the model of the RS circuit 10.

The corresponding code, for instance in C++ language, is shown below in Tab.7, commented in order to clarify the functions for interfacing to the configuration file 140:

TABLE 7
CONFIGURATION INTERFACE BLOCK FOR RS IN C++

```
#include <stdio.h>
#include “rs_decoder.h”
void main(int argc, char*argv[])
{
// Assertion of inputs and outputs of the Reed Solomon
  int data;
  int dval, start;
// Assertion of internal variables
  int i, j, l, col, n_pack;
  FILE *fgen;
  char line[80];
// Assertion of the configuration parameters
  int n, k, m, h, gp;
// Reading of the Reed Solomon configuration file
  fgen = fopen(argv[1], “r”);
  if (fgen == NULL) {
  printf (“Cannot open parameters file \‘%s\’.\nProgram terminated
abnormally.\n\n”,
      argv[1]);
  exit (1);
  }
  printf (“Reading generics from file \‘%s\’...\n”, argv[1]);
  fgets (line, 79, fgen); // Reading of the parameter N
  sscanf (line, “%d”, &n);
  printf (“N = %d\n”, n);
  fgets (line, 79, fgen); // Reading of the parameter K
  sscanf (line, “%d”, &k);
  printf (“K = %d\n”, k);
  fgets (line, 79, fgen); // Reading of the parameter M
  sscanf (line, “%d”, &m);
  printf (“M = %d\n”, m);
  fgets (line, 79, fgen); // Reading of the parameter H
  sscanf (line, “%d”, &h);
  printf (“H = %d\n”, h);
  fgets (line, 79, fgen); // Reading of the parameter GENPOL
  sscanf (line, “%d”, &gp);
  printf (“GENPOL = %d\n\n”, gp);
```

In accordance with an additional peculiar characteristic of the present invention, the description of the software test bench module 214, 216 must be realised in such a way as to allow to configure the model of the circuit with no need to make modifications to its description.

For instance, in the case of RS circuit model 10, the description of the test bench module, relative to the application block part, shall be able to configure the model of the Reed Solomon with no need to make modifications to the code of the same model or to repeat compilation operations. Said characteristic is obtained by intrinsically defining the data structures according to the parameters and using the “BitVector” class of the C++ language, which allows to control its accuracy (in the Reed Solomon model defined by the parameter M).

In detail, the instancing of the RS circuit model 10 requires, for instance, use of an application block that contains all parameters necessary and sufficient to configure the model.

An example of code in C++ language the meets said additional characteristic is provided below in Tab.8 with related explanatory comments:

TABLE 8
RS CONFIGURATION APPLICATION BLOCK IN C++

// Definition of GENPOL precision in relation to the value of M
BitVector genpol = ToBitVector(gp, m+1);
// Definition of the input data vector as a function of N
BitVector data_in[n], *res;
// Configuration of the precision of the inputs as a function of the
parameter M
for (i = 0; i < n; i++) data_in[i].init(m);
// Instancing of the RS decoder configured with the parameters read from
file
RS_Decoder rs_dec(n, k, m, genpol, h);

The hardware test bench module, relative to the interface block part, similarly to the description provided for the software test bench module, must be generated in such a way as to be able to read the same configuration file 140, as shown in Tab.6, and univocally define its interface and the RS circuit to be realised, with the sole difference, as stated previously, that, in this latter case, it must be able to manage also the FWSIZE and MEM_CONF architectural parameters.

The configuration file 140 used is, as stated previously, the same one as provided for the software test bench module; in particular, the numerical values of the parameters are read as whole values by means of known “read” functions, whilst the comments on the same line are ignored.

The code in VHDL language of said module is provided below in Tab.9 with related explanatory comments:

TABLE 9
RS CONFIGURATION INTERFACE BLOCK IN VHDL

```
package RS_DEC_TST_PACK is
-- Definition of the parameters in the form of ‘record’ data structure
type T_RS_DEC_GEN is record
  N : integer;
  K : integer;
  M : integer;
  H : integer;
  GENPOL : integer;
  FWSIZE : integer;
  MEM_CONF : integer;
  end record;
  -- Assertion of the configuration file reading function
function GET_RS_DEC_GEN return T_RS_DEC_GEN;
  end RS_DEC_TST_PACK;
package body RS_DEC_TST_PACK is
-- Definition of the configuration parameters reading function
function GET_RS_DEC_GEN return T_RS_DEC_GEN is
  variable RESULT : T_RS_DEC_GEN;
-- Assertion of internal variables for reading the configuration file
  variable SD : line := new string'(“scen.” & GET_SCEN);
  variable SCENDIR : string (1 to SD'length) := SD.all;
  file INFILE : text is in SCENDIR & “/rs_decoder.gen”;
  variable INLINE : line := new string'(“”);
  variable OK : boolean;
begin
  -- Configuration file reading indication
  assert false
  report “Loading generics from file: ” & SCENDIR & “/rs_{—}
decoder.gen”
  severity note;
  -- Reading the Reed-Solomon Decoder parameters from file
-- Reading the N parameter
  readline (INFILE, INLINE);
  read (INLINE, RESULT.N, OK);
  assert OK
  report “Error while reading parameter N”
  severity failure;
-- Reading the parameter K
  readline (INFILE, INLINE);
  read (INLINE, RESULT.K, OK);
  assert OK
  report “Error while reading parameter K”
  severity failure;
-- Reading the parameter M
  readline (INFILE, INLINE);
  read (INLINE, RESULT.M, OK);
  assert OK
  report “Error while reading parameter M”
  severity failure;
-- Reading the parameter H
  readline (INFILE, INLINE);
  read (INLINE, RESULT.H, OK);
  assert OK
  report “Error while reading parameter H”
  severity failure;
-- Reading the parameter GENPOL
  readline (INFILE, INLINE);
  read (INLINE, RESULT.GENPOL, OK);
  assert OK
  report “Error while reading parameter GENPOL”
  severity failure;
-- Reading the architectural parameter FWSIZE
  readline (INFILE, INLINE);
  read (INLINE, RESULT.FWSIZE, OK);
  assert OK
  report “Error while reading parameter FWSIZE”
  severity failure;
-- Reading the architectural parameter MEM_CONF
  readline (INFILE, INLINE);
  read (INLINE, RESULT.MEM_CONF, OK);
  assert OK
  report “Error while reading parameter MEM_CONF”
  severity failure;
  return RESULT;
  end GET_RS_DEC_GEN;
  end RS_DEC_TST_PACK;
```

Naturally, the hardware test bench module is able to read the parameters from the same configuration file 140, used by the software test bench module, to configure, during the initialisation phase, the precision of inputs and outputs of the circuit and to define the architecture of the circuit itself.

As a further characteristic the hardware test bench module, relative to the application block part, does not require, as will be readily apparent to a person versed in the art from the VHDL language code of Tab.10, to compile or to modify the RS component as the configuration parameters vary.

An example of said hardware test bench module, able to apply the configuration parameters to the RS circuit, is provided below in Tab.10:

TABLE 10
RS CONFIGURATION APPLICATION BLOCK IN VHDL

```
architecture STRS of RS_DEC_TB is
  constant RS_DEC_GEN : T_RS_DEC_GEN := GET_{—}
  RS_DEC_GEN;
  // Run-time reading (at simulation start) of configuration parameters
  constant N : integer := RS_DEC_GEN.N;
  constant K : integer := RS_DEC_GEN.K;
  constant M : integer := RS_DEC_GEN.M;
  constant GENPOL : integer := RS_DEC_GEN.GENPOL;
  constant H : integer := RS_DEC_GEN.H;
  constant ARCH_TYPE : integer := 0;
  constant FWSIZE : integer := RS_DEC_GEN.FWSIZE;
  constant MEM_CONF : integer := RS_DEC_GEN.MEM_CONF;
...
signal N_RST : std_ulogic;
  signal CLK : std_ulogic := ‘0’;
  -- Assertion of the Reed Solomon input and output signals with precision
depending on the parameter M
  signal RS_DATA_I, RS_DATA_O : std_ulogic_{—}
  vector (M−1 downto 0);
  -- Assertion of the input and output data synchronisation signals
  signal RS_DVAL_I, RS_DVAL_O : std_ulogic;
  signal RS_START_I, RS_START_O : std_ulogic;
  -- Assertion of additional decoding status testing signals
  signal RS_ERROR_O : std_ulogic;
  signal RS_ERRCNT_O : std_ulogic_vector
  (LOG2C(((N−K)/2)+1)−1 downto 0);
  signal RS_FAIL_O : std_ulogic;
  -- Interface signals towards the memory component
signal MEM_CLK, MEM_N_CLK : std_ulogic;
  signal DATA_WR_P1, DATA_RD_P1 : std_ulogic_vector
  (FWSIZE-1 downto 0);
  signal DATA_P1 : std_logic_vector (FWSIZE-1 downto 0);
  signal ADDR_P1 : std_ulogic_vector (GET_FIFO_SIZE(N,
  FWSIZE, M)−1 downto 0);
  signal CS_P1, WEN_P1, OEN_P1, WR_RD_P1 : std_ulogic;
  signal DATA_WR_P2, DATA_RD_P2 : std_ulogic_vector
  (FWSIZE-1 downto 0);
  signal DATA_P2 : std_logic_vector (FWSIZE-1 downto 0);
  signal ADDR_P2 : std_ulogic_vector (GET_FIFO_SIZE(N,
  FWSIZE, M)−1 downto 0);
  signal CS_P2, WEN_P2, OEN_P2, WR_RD_P2 : std_ulogic;
begin -- STRS
  -- Generation of the primary hardware synchronisation and reset signals
N_RST <= ‘0’, ‘1’ after 10 ns;
  CLK <= not(CLK) after 25 ns;
  MEM_CLK <= CLK;
  MEM_N_CLK <= not(CLK);
  -- Instancing of the interface component to the Reed-Solomon Decoder
  I_RS_STIMGEN: RS_DEC_STIMGEN
  generic map (M => M)
  port map (
    N_RST => N_RST,
    CLK => CLK,
    RS_DATA_I => RS_DATA_I,
    RS_DVAL_I => RS_DVAL_I,
    RS_START_I => RS_START_I,
    RS_DATA_O => RS_DATA_O,
    RS_DVAL_O => RS_DVAL_O,
    RS_START_O => RS_START_O);
-- Instancing of the Reed-Solomon Decoder component
I_RS_DEC: RS_DECODER
  -- Application of the configuration parameters
  generic map (
  N => N,
  K => K,
  M => M,
  H => H,
  GENPOL => GENPOL,
  FWSIZE => FWSIZE,
  MEM_CONF => MEM_CONF)
  -- Application of all Reed-Solomon signals previously stated and
  -- configured as a function of the parameters
  port map (
  N_RST => N_RST,
  CLK => CLK,
  DATA_I => RS_DATA_I,
  DVAL_I => RS_DVAL_I,
  START_I => RS_START_I,
  DATA_O => RS_DATA_O,
  DVAL_O => RS_DVAL_O,
  START_O => RS_START_O,
  ERROR_O => RS_ERROR_O,
  ERRCNT_O => RS_ERRCNT_O,
  FAIL_O => RS_FAIL_O,
  MEM_CLK => MEM_CLK,
  MEM_N_CLK => MEM_N_CLK,
  DATA_WR_P1 => DATA_WR_P1,
  DATA_RD_P1 => DATA_RD_P1,
  DATA_P1 => DATA_P1,
  ADDR_P1 => ADDR_P1,
  CS_P1 => CS_P1,
  WEN_P1 => WEN_P1,
  OEN_P1 => OEN_P1,
  WR_RD_P1 => WR_RD_P1,
  DATA_WR_P2 => DATA_WR_P2,
  DATA_RD_P2 => DATA_RD_P2,
  DATA_P2 => DATA_P2,
  ADDR_P2 => ADDR_P2,
  CS_P2 => CS_P2,
  WEN_P2 => WEN_P2,
  OEN_P2 => OEN_P2,
  WR_RD_P2 => WR_RD_P2);
-- Instancing of the memory component external to the Reed-Solomon
I_DPRAM: DPRAM_SYNC
  generic map (
  -- Application of the configuration parameters
  WSIZE => FWSIZE,
  ASIZE => GET_FIFO_SIZE(N, EWSIZE, M),
  DPRAM_SYNC_CONF => 8)
  -- Application of all signals of the memory component
  -- configured as a function of the parameters applied to the
Reed-Solomon decoder
  port map (
  DATA_WR_P1 => DATA_WR_P1,
  DATA_RD_P1 => DATA_RD_P1,
  ADDR_P1 => ADDR_P1,
  WCLK_P1 => MEM_CLK,
  ACLK_P1 => MEM_CLK,
  CS_P1 => CS_P1,
  WEN_P1 => WEN_P1,
  OEN_P1 => OEN_P1,
  DATA_WR_P2 => DATA_WR_P2,
  DATA_RD_P2 => DATA_RD_P2,
  ADDR_P2 => ADDR_P2,
  WCLK_P2 => MEM_CLK,
  ACLK_P2 => MEM_CLK,
  CS_P2 => CS_P2,
  WEN_P2 => WEN_P2,
  OEN_P2 => OEN_P2);
end STRS;
```

As will be readily apparent to a person versed in the art, the hardware test bench module further comprises, because of the greater accuracy, signals towards a memory component external to the Reed Solomon circuit, not shown in the present description and kept isolated therefrom because it generally depends on the technology for realising the circuit and on signals for testing the internal and synchronisation status.

In the software test bench module a corresponding memory model is a part of the RS circuit module 10 and therefore the software test bench module (Tab.9) does not comprise signals of this kind at its interface.

Naturally, in the software test bench module (Tab.9) the synchronisation and status signals are absent, since this information is not necessary in that context.

The stimuli file 150 comprises the set of stimuli to be applied to the RS circuit module 10 and to the RS circuit and, as previously stated, it must be readable both by the software test bench module and by the hardware test bench module.

This type of file 150 can be prepared manually or generated with an appropriate programme, depending on model and circuit testing requirements.

In accordance with an additional peculiar characteristic, the stimuli file 150 must allow exhaustively to test both the functionalities, described in both software and hardware models, and the specific performance of the architectural model of the circuit, such as processing capacity over time and circuit delays.

Briefly, the stimuli file 150 must, in the first place, use a single format to provide the stimuli in all the allowed configurations of the software and hardware models of the circuits to be realised and, in the second place, it shall enabling easily to extract both the information for the functional test and the additional synchronisation information, whilst allowing complete independence on the type and number of the data.

The stimuli file 150 corresponds, for instance, to the characteristics indicated by means of a text format that shows synchronous information on each line and identifies data and synchronisation signals (data) by column.

In detail, each row of the stimuli file 150 corresponds, for instance, to a clock cycle in which the data item can be either considered (valid data item) or ignored (invalid data item); for each row, moreover, the first data item (first column) identified, for instance, the value of the symbol, the second data item (second column) identifies a symbol that is either valid (value ‘1’) or to be ignored (value ‘0’) and the third data item (third column) defines the start of a new block (value ‘1’) or the continuation of the current block (value ‘0’).

The following Tab.6bis provides an example of stimuli file 150 with such a format, naturally limited in size to what is required to comprehend the characteristics of this type of file.

TABLE 6BIS
RS STIMULI FILE

```
132 0 0 -- Symbol with value 132, not valid
  0 0 0 -- Symbol with value 0, not valid
  0 0 0 -- Symbol with value 0, not valid
220 1 1 -- Symbol with value 220, first valid data item, start of a block
122 1 0 -- Symbol with value 122, second valid data item, same block
233 1 0 -- Symbol with value 233, third valid data item, same block
142 1 0 -- Symbol with value 142, fourth valid data item, same block
(Omitted lines) ...
712 0 0 -- Symbol with value 712, not valid
172 1 0 -- Symbol with value 172, valid data item, same block
  0 1 1 -- Symbol with value 0, first valid data item, start of a new block
  16 1 0 -- Symbol with value 16, second valid data item, same block
  9 1 0 -- Symbol with value 9, third valid data item, same block
(Omitted lines) ...
```

The described format allows the insertion and positioning of any number of valid symbols and of invalid symbols, with the aim of exhaustively testing the protocols and the correct operation of the RS circuit model 10 and of the corresponding circuit.

Naturally, if the stimuli file comprises words whose size is less than N, as defined by the parameter N in the configuration file 140, said words, during the processing phase, are ignored by the RS circuit model and by the circuit, in accordance with the present embodiment.

The software test bench module (Tab.11), similarly to what is described for the configuration file 140, is able to read the stimuli file 150 (Tab.6bis) extracting the information that is useful to perform the functional simulation of the RS circuit 10; said information coincides with the value of the symbol, the “valid symbol” and “new block” indication.

The description, for instance in C++ language, of the software test bench module, 214, 216, is, as exemplified below in Tab.11, able to read the stimuli file 150 and to apply it to the RS circuit model 10, and is therefore independent from the type of stimuli used.

The description of the software test bench module, 214 216, is in accordance with an additional characteristic of the present invention, also able to write the results of the simulation, for instance at the output from the RS circuit model 10, in a format that is convenient both to conduct an automatic error check and to certify, by comparison, the results of the architectural simulation carried out with corresponding hardware test bench module, as shall be described in detail hereafter.

An example of software test bench module for RS circuit models 10 relating to the management of the stimuli file 150 is provided below in (Tab.11).

TABLE 11
RS TEST BENCH MODULE IN C++ FOR STIMULI

```
// Opening the input (stimuli) and output (decoded symbols) files of the
Reed Solomon
  FILE* fin = fopen (argv[2], “r”);
  FILE* fout = fopen (argv[3], “w”);
  // Error check on opening the files
  if (fin == NULL ∥ fout == NULL) {
  printf (“Error while opening in/out files!\nProgram terminated
abnormally.\n\n”);
  exit (2);
  }
  printf (“\nStimulus file = %s\nOutput file = %s\n\n”, argv[2], argv[3]);
  printf (“Running...\n”);
  // Initialisation of the symbol and block number count
  i = 0;
  col = 0;
  n_pack = 1;
  while (!feof(fin)) {
  // Reading the stimuli from file (i.e. the symbols at the input of the
      decoder)
  // For each line three data items are read (corresponding to the three
columns):
  // date is the symbol, dval=1 indicates ‘valid data item’, start=1
indicates a new block
  fscanf (fin, “%d %d %d\n”, &data, &dval, &start);
  // Starts a new block every time start=1 (third column of the stimuli file)
  if (start == 1) i = 0;
  // Considers only the valid data and updates the count in the current
      block
  if (dval == 1)
    data_in[i++] = ToBitVector(data, m);
  if (i == n) {
    i = 0;
    printf (“Packet n. %d \r”, n_pack++);
    fflush (stdout);
    // Call of the decoder RS to which a block of N valid input symbols,
    // corresponding to a block, is passed
    res = rs_dec.run(data_in);
    // Writing the output symbols from the Reed-Solomon decoder on file
    // Scanning cycle of all the symbols of a block
    for (j = 0; j < n; j++) {
    // Scanning cycle of all the bits of a symbol
    for (l = 0; l < m; l++) {
      fprintf (fout, “%c”, ( ToUnsigned((res[j])(m − 1 − 1)) ==
      0 ? ‘0’ : ‘1’));
      col++;
    // Formatting the outputs on a predefined number of columns
        if (col == 50) {
      fprintf (fout, “\n”);
      col = 0;
      }
        }
    }
  }
  }
  printf (“...done. \n\n”);
}
```

The corresponding description of the “test bench” hardware module, 314 316, shown below in Tab.12, is, as previously stated, able to read the stimuli file 150 and to produce an output file in the same format as the one produced in the software test bench module.

A first difference between the software and the hardware test bench module is the presence, in the hardware test bench module (Tab.12), of synchronisation signals, which, as will be obvious to a person versed in the art, are aimed at using the timing information of the data.

Moreover, whilst the software test bench module (Tab.11) of the RS circuit model 10 is able to read and store the data to units of blocks of size N, the hardware test bench module (Tab.12) is able to read the information that arrive in the same synchronism period, a symbol at the time.

Since the format of the stimuli file (Tab.6bis) identifies each synchronisation period on a distinct line, the reading of the stimuli file 150, by the hardware test bench module is executed one line at a time.

The presence of non valid data, as will be readily apparent to a person versed in the art, is not ignored by causes the creation of appropriate control signals, in order to verify the correctness of behaviour of the RS circuit with wholly generic successions of data.

While managing the complete synchronisation and signalling of the data for each symbol and block, the values used are only those already seen for the software model, equivalent to the data, dval and start variable already reported and commented in Tab.11, demonstrating that the format of the stimuli file in Tab.6bis encloses all information necessary both to the software and to the hardware test benches.

The following Tab.12 shows an example of hardware test bench module for RS circuit:

TABLE 12
RS TEST BENCH MODULE IN VHDL FOR STIMULI

```
architecture BEHAV of RS_DEC_STIMGEN is
  -- Assertion of the signals corresponding to the value of the symbol
(RS_DATA_INT),
  -- at the indication ‘dato_valido’ (RS_DVAL_INT) and ‘new block’ (RS_START_INT)
  signal RS_DATA_INT : std_ulogic_vector (M−1 downto 0);
  signal RS_DVAL_INT : std_ulogic;
  signal RS_START_INT : std_ulogic;
begin -- BEHAV
  -- Assertion of the variables for the reading of the stimuli from file
  READ_DATA: process (CLK, N_RST)
  variable SD : line := new string'(“scen.” & GET_SCEN);
  variable SCENDIR : string (1 to SD'length) := SD.all;
  file INFILE : text is in SCENDIR & “/input_data.dat”;
  variable INLINE : line := new string'(“”);
  variable VALUE : integer;
  variable OK : boolean;
  -- Assertion of the internal status variable
  type T_STATUS is (read_new_data, end_of_data);
  variable STATUS : T_STATUS := read_new_data;
  begin -- process READ_DATA
  -- Management of the asynchronous Reset signal
  if N_RST = ‘0’ then
    RS_DATA_INT <= (others => ‘0’);
    RS_DVAL_INT <= ‘0’;
    RS_START_INT <= ‘0’;
    STATUS := read_new_data;
  -- Synchronisation of all symbol reading and check generating operations
  elsif CLK'event and CLK = ‘1’ then
    if STATUS = read_new_data then
    -- Stimuli file end check
    if endfile(INFILE) then
      assert false report “End of data transmission.” severity note;
      STATUS := end_of_data;
    else
      -- Reading of a line of the file (asynchronous data)
      readline (INFILE, INLINE);
      -- Extracting the value of the symbol with precision defined by the parameter M
      read (INLINE, VALUE, OK);
      RS_DATA_INT <= std_ulogic_vector(conv_std_logic_vector(VALUE, M));
      -- Extracting the ‘valid data item’ information and generating RS_DVAL_INT
      read (INLINE, VALUE, OK);
      if VALUE = 0 then
      RS_DVAL_INT <= ‘0’;
      else
      RS_DVAL_INT <= ‘1’;
      end if;
      -- Extracting the ‘new block’ information and generating RS_START_INT
      read (INLINE, VALUE, OK);
      if VALUE = 0 then
      RS_START_INT <= ‘0’;
      else
      RS_START_INT <= ‘1’;
      end if;
    end if;
    else
    -- Completing the last block with symbols at zero
    RS_START_INT <= ‘0’;
    RS_DVAL_INT <= ‘0’;
    RS_DATA_INT <= (others => ‘0’);
    end if;
    end if;
  end process READ_DATA;
  -- Using the generated signals as inputs (data and check) of the Reed Solomon
Decoder
  RS_DATA_I <= RS_DATA_INT;
  RS_DVAL_I <= RS_DVAL_INT;
  RS_START_I <= RS_START_INT;
  -- Writing the output symbols from the Reed-Solomon on file
  WRITE_DATA: process (CLK)
  -- Assertion of the variables for writing the decode symbols on file
variable SD : line := new string'(“scen.” & GET_SCEN);
  variable SCENDIR : string (1 to SD'length) := SD.all;
  file OUTFILE : text is out SCENDIR & “/output_data.log”;
  variable OUTLINE : line := new string'(“”);
  variable CHAR_COUNT : integer := 0;
  begin -- process WRITE_DATA
  -- Synchronsing all writing operations
  if CLK'event and CLK = ‘1’ then
    -- Writing only the valid decoded symbols
    if RS_DVAL_O = ‘1’ then
    -- Scanning cycle of all bits of a symbol (equal to the parameter M)
      for I in M−1 downto 0 loop
      if RS_DATA_O (I) = ‘0’ then
        WRITE (OUTLINE, string'(“0”));
      elsif RS_DATA_O (I) = ‘1’ then
        WRITE (OUTLINE, string'(“1”));
      end if;
      -- Formatting the output file on a predefined number of columns
      CHAR_COUNT := CHAR_COUNT + 1;
      if CHAR_COUNT >= 50 then
        CHAR_COUNT := 0;
        writeline (OUTFILE, OUTLINE);
      end if;
    end loop; -- I
    end if;
  end if;
  end process WRITE_DATA;
end BEHAV;
```

The description of the method according to the invention has been heretofore provided in detail for the phases relating to the generation of the electronic circuit models and of the test bench modules, step 210.

The description of the flow 100 (FIG. 2) of the design of electronic circuits is provided hereafter in order further to clarify the characteristics of the present invention.

In a first functional development and testing cycle (step 200), first of all, a functional description (step 210) is generated, based on the design specifications 110 relating to the complex electronic circuit to be realised.

The step 210 comprises, as amply described, a description phase of the functional model of an elementary electronic circuit (step 212) and a description phase of the software test bench module (steps 214 and 216) whereof the first step is aimed at making the circuit model universally usable, the second step at making the circuit model independent from the external data, constituted for instance by the configuration file 140 and by the stimuli file 150.

Once the step 210 is completed, the flow 100 comprises, as the subsequent step, the functional simulation of the electronic circuit model (step 220).

The step 220 is conducted using, as inputs, external data (140, 150) representing, as described, configuration parameters and stimuli and/or data necessary to simulate the electronic circuit, and it is able to generate as outputs resulting from the simulation, files representing the behaviour of the circuit model.

The function simulation 220, thanks to one of the characteristics of the present invention, can be reiterated several times, simply varying the external data (140, 150) and without modifying the description generated in the step 210.

Subsequent to the step 220, a phase of checking the results of the simulation (step 225) is provided.

A negative outcome of the check is, for instance, indicative that the description generated in the step 210 does not allow to manage, in accordance with the specifications 110 and as the external data (140 and 150) vary, the electronic circuit model and, therefore, in this case the step 210 is repeated to make the description meet, for instance, the requirements of independence from variations in the external data (140, 150).

A positive outcome of the check allows to freeze in an output file (step 230) the results of the simulation, in order to make them available to the design flow 100, as shall be described in detail hereafter.

The first development and testing cycle (step 200) allows not only to generate a determined functional model of electronic circuit validated by the simulation, but enables also to verify whether the description (step 210) does in fact meet the requirements of universality and independence from the external data (140, 150) and, thus, said first cycle also assures that, for any variation of the external data (140, 150), it is not necessary to vary the description but it is sufficient to repeat the simulation with a set of different external data (140, 150).

This second effect is all the more important the more the electronic circuit model, such as the Reed Solomon decoding model, requires, due to design demands, a high number of configuration modifications and/or of data necessary for the simulation.

In a second architectural development and testing cycle (step 300), a description of the electronic circuit (step 310) is first of all generated, based on the design specifications 110 relating to the electronic circuit to be realised.

The step 310 comprises, as amply described, a phase of actual description of the electronic circuit (step 312) and a phase of description of the hardware test bench module (steps 314 and 316) whereof the first step is aimed at making the circuit equivalent to the circuit model described in the step 210, the second step is aimed at making the same circuit independent from the external data, constituted, as amply described, by the same configuration files 140 and stimuli 150 used for the functional simulation 220.

Once the step 310 is completed, the flow 100 comprises, as subsequent step, the architectural simulation of the electronic circuit (step 320).

The step 320 is conducted using, as inputs, configuration parameters and stimuli and/or data necessary to simulate the electronic circuit (140, 150), already described, and it is able to generate as outputs, resulting from the simulation, files representing the behaviour of the electronic circuit. The architectural simulation 320, thanks to one of the characteristics of the present invention, can be reiterated several times simply by varying the external data (140, 150) and without modifying the description generated in the step 310.

Subsequently to the step 320, a phase of checking the results of the simulation (step 325) is provided.

A negative outcome of the check, in accordance with the present embodiment and with the present invention, has no effect on the first development and testing cycle 200, and is, for instance, indicative that the description generated in the step 310 is not equivalent to the one generated in the step 210 and does not allow to manage the electronic circuit, as the external data (140 and 150) vary; in case of negative outcome, therefore, the step 310 is repeated to make the description of the circuit such as to meet the design specifications (110) of the circuit itself.

A positive outcome of the check allows to freeze in an output file (step 330) the results of the architectural simulation and to proceed with an additional characteristic step of the present invention, represented by a phase of automatic comparison (step 333) between the output file (step 330) from the first development and testing cycle (200) and the output file from the second development and testing cycle (300).

The step 333 can be conducted automatically, as can be easily derived by a person versed in the art, based on the example already provided in language C++ and VHDL, in the test bench modules of Tab.11 and Tab.12, respectively, thanks to the adoption of a simple but effective format for this purposes, in which, for instance, every bit of each symbol decoded by the RS circuit model and by the RS circuit is written in succession using the characters ‘0’ and ‘1’.

After the automatic comparison step 333 a phase (step 335) of checking the results of the automatic comparison is provided.

A negative outcome of the check of the results, once again, has no effects on the first development and testing cycle 200, and is, for instance, indicative that the characteristics of the circuit, in particular, do not meet the requirements for the physical realisation thereof.

A positive outcome of the check of the results allows to proceed to a synthesis compilation phase (step 500) able to obtain the physical layout of the electronic circuit to be realised, “hitching”, in a known manner, a library of physical components to the compiled model for the architectural simulation.

As results of said step 500, it will be possible to obtain as outputs, as will be readily apparent to a person versed in the art, both the information needed for the physical realisation of a complex integrated circuit or SOC, so-called FULL CUSTOM, which can naturally be obtained from the company supplying the physical libraries “linked” to the compiled module (step 510) and, alternatively, the information needed for the physical programming of programmable components (step 520), such as FPGA (Field Programmable Gate Arrays) components.

The second development and testing cycle (step 300) not only allows to generate a determined electronic circuit validated by means of simulation, but allows also to verify whether the architectural description (step 310) meets requirements of universality and independence from external data (140, 150) and, thus, also said second cycle assures that, for any variation of the external data (140, 150) it is not necessary to vary the architectural description but it is sufficient to repeat the simulation with a set of different external data (140, 150).

This second effect is all the more important the more the electronic circuit, such as the Reed Solomon decoding circuit, requires, due to design demands, a high number of configuration modifications and/or of data needed for simulation.

The use of a shared configuration file 140 and stimuli file 150, and of output files in the same format, by the functional and architectural simulation, allows both to use an integrated simulation environment for the software and hardware models of the circuits, and the ability to conduct the same tests on corresponding types of models and directly comparing the results.

Moreover, the use of a shared configuration file 140 and stimuli file 150 is particularly useful, in particular, in situations in which each of the two types of models is able to generate a multiplicity of circuits, for example in the case of the Reed Solomon models, and in which each of these models can be tested with many types of stimuli, such as a typical transmission content of an actual application or of a specific standard.

The use of a common configuration file 140 and stimuli file 150 is particularly valuable if it is possible to verify the complete consistency of the two types of models, by means of an automatic comparison (step 333), with precision down to the bit, of the results of the simulations.

Said verification of the simulation results allows to ascertain and assert the absolute interchangeability of the two type of models in simulation, and it also assures that the model that can be realised in hardware yields the same results obtained by means of exhaustive simulations of the software model.

The software model can thus be used instead of the hardware model, both during the first development cycle 200, starting from the specifications alone, and during and after the realisation of the hardware model to verify the performance of each new generated circuit by means of a determined configuration file 140 and as the input stimuli 150 vary, verifying, for instance in the case of Reed Solomon decoder, their behaviour with different types of transmission and of noise injected into the code words contained in the stimuli file (150).

The method embodiments of present invention may be implemented, as a person skilled in the art can appreciate, as computer programs products for use with a computer system, as those skilled in the art should readily appreciate.

In particular, the functional and architectural models according to the invention can be delivered to a computer in many forms, including, but not limited to: information permanently store on non-writable storage media and information alterably stored on writable storage media.

Obvious modifications or variations are possible to the above description, in dimensions, shapes, materials, components, circuit elements, connections and contacts, as well as in the details of the circuitry and of the construction illustrated herein and of the operating method without thereby departing from the spirit of the invention as set out in the claims that follow.

1. Method for generating electronic circuits comprising the following steps
describing with a first programming language (C++) a circuit model (212) able to perform processing functions and a test bench module (214, 216) able to configure and/or stimulate said processing functions according to a plurality of sets of input information (140, 150);
activating the processing functions (220) of said circuit model on the basis of a determined set of input information and generating a first set of output information (230) representative of the results of said activation of processing functions (220);
describing with a second programming language (VHDL) a circuit (312) able to realise said processing functions and an additional test bench module (314, 316) able to configure and/or stimulate said circuit on the basis of said plurality of sets of input information (140, 150); and
simulating the behaviour (320) of said circuit on the basis of said determined set of input information and generating a second set of output information (330) representative of the result of said simulation and having an equivalent format to said first set of output information (230).

2. Method as claimed in claim 1, characterised by the additional step of
automatically comparing (333) said first set of output information (230) with a second set of output information (330), whereby in case of equivalence between said first set of output information (230) and said second set of output information (330) said circuit is determined as equivalent to said circuit model.

3. Method as claimed in claim 1 or 2, characterised in that
said sets of input information (140, 150) comprise parametric configuration data (140) able to determine the characteristics of said electronic circuit and/or data to be processed (150).

4. Method as claimed in claim 1 or 2, characterised in that
the step of describing a test bench module (214, 216) comprises the steps of
describing a first block of instructions (214) able to interface said circuit model to said sets of input information (140, 150); and of
describing a second block of instructions (216) able to apply said sets of information (140, 150) to said circuit model.

5. Method as claimed in claim 1, 2 or 4 characterised in that
the step of describing an additional test bench module (314, 316) comprises the steps of
describing a first block of instructions (314) able to interface said circuit model to said sets of input information (140, 150); and of
describing a second block of instructions (316) able to apply said sets of information (140, 150) to said circuit model.

6. Method as claimed in claim 1 or 2, characterised by the additional step of
physically realising a complex FULL CUSTOM electronic circuit (500, 510) by means of a process of synthesising said electronic circuit.

7. Method as claimed in claim 1 or 2, characterised by the additional step of
physically realising a complex FPGA electronic circuit (500, 520) by means of a process of synthesising said electronic circuit.

8. Method as claimed in any of the previous claims, characterised in that said electronic circuit is a Reed Solomon decoding circuit.

9. Method as claimed in any of the previous claims, characterised in that said first programming language is a C++ language and wherein said second programming language is VHDL.

10. Computer programs products loadable in an internal memory of an electronic computer for implementing the method as claimed in claims 1 to 9.
